(19) United States
(12) Patent Application Publication
(10) Pub. No.: US 2020/0367667 A1
(43) Pub. Date: Nov. 26, 2020

(54) TEETHING CRIB RAIL AND ENTERTAINMENT PAD

(71) Applicant: Maria WYNN, Montclair, NJ (US)

(72) Inventor: Maria WYNN, Montclair, NJ (US)

(21) Appl. No.: 16/496,464

(22) PCT Filed: Mar. 20, 2018
(86) PCT No.: PCT/US2018/023309

§ 371 Date: Sep. 23, 2019

Related U.S. Application Data
(60) Provisional application No. 62/474,829, filed on Mar. 22, 2017.

(51) Int. Cl. A47D 15/00; A47D 9/00

(52) U.S. Cl. CPC A47D 15/00; A61J 17/02; A47D 9/00

(57) ABSTRACT

A teething rail assembly comprising:
(a) a lower teething rail pad;
(b) an upper teething rail mounted on and partially covering the lower teething rail pad; and
(c) an LCD screen mounted in or on the lower teething rail pad; the upper teething rail being configured so that when the teething rail assembly is mounted onto a crib rail, the upper teething rail holds the entire teething rail assembly in place on the crib rail; a portion of the lower teething rail pad hangs beneath the upper teething rail; and the LCD screen is mounted in or on the portion of the lower teething rail pad that hangs beneath the upper teething rail and is visible and accessible to a child in the crib.

### PRIORITY CLAIM

This application claims priority of U.S. Provisional Application Ser. No. 62/474,829, filed Mar. 22, 2017, the contents of which are hereby incorporated by reference.

### BACKGROUND OF THE INVENTION

### 1. Field of the Invention

The present invention relates to a device to secure to the rail of the crib of a teething child to aid that child in dealing with the pain and discomfort associated therewith.

### 2. Description of Related Art

Devices that attach to the railing of a crib to assist a child in teething are known. For example, Perry, U.S. Pat. No. 8,234,734, describes a modular system of rail covers that can be secured to the crib rail and have surface features that a teething child can chew on and obtain relief from the pain and discomfort of teething. While the modular rail covers cover the crib rail itself and prevent a child from chewing on the horizontal crib rail, the rail covers do not cover the vertical crib bars and, therefore, do not prevent the child from chewing on the vertical bars.

On the other hand, Schmidt, U.S. Publication 2015/0302721, describes a crib including monitoring devices for monitoring a child, wherein the monitoring devices are integrated into the crib itself. However, the crib rails are unprotected and, therefore, a teething child is free to chew on and disfigure the construct.

An object of the present invention was to provide a device that could be attached to various commercial cribs, and would prevent a teething child from chewing on the crib rails or substantial portions or all of the crib bars, yet could integrate an entertainment system to soothe, stimulate and distract the teething child as desired.

### SUMMARY OF THE INVENTION

These and other objects were met in a first embodiment with a teething rail pad assembly comprising:

(a) a lower teething rail pad;

(b) an upper teething rail mounted on and partially covering the lower teething rail pad; and

(c) an LCD screen mounted in or on the lower teething rail pad;

wherein the upper teething rail has a cross-sectional shape in at least a portion of the upper teething rail such that when the teething rail pad assembly is mounted onto a crib rail, said at least a portion of the upper teething rail holds the entire teething rail pad assembly in place on the crib rail;

wherein the lower teething rail pad and the upper teething rail are configured such that when the teething rail pad assembly is mounted onto said crib rail, a portion of the lower teething rail pad hangs beneath the upper teething rail; and

wherein the LCD screen is mounted in or on the portion of the lower teething rail pad that hangs beneath the upper teething rail and is visible and accessible to a child in the crib.

A second embodiment concerns a teething rail pad assembly as described hereinabove, but lacking the LCD screen, such teething rail pad assembly also comprising:

(a) a lower teething rail pad; and

(b) an upper teething rail mounted on and partially covering the lower teething rail pad;

wherein the upper teething rail has a cross-sectional shape in at least a portion of the upper teething rail such that when the teething rail assembly is mounted onto a crib rail, said at least a portion of the upper teething rail holds the entire teething rail assembly in place on the crib rail; and

wherein the lower teething rail pad and the upper teething rail are configured such that when the teething rail assembly is mounted onto said crib rail, a portion of the lower teething rail pad hangs beneath the upper teething rail.

A third embodiment of the present invention relates to a kit comprising:

(a) at least one teething rail assembly comprising the LCD screen, as described hereinabove; and

(b) at least one teething rail assembly lacking the LCD screen, as also described hereinabove.

### BRIEF DESCRIPTION OF THE SEVERAL VIEWS OF THE DRAWINGS

There are four drawings in total that describe and illustrate the design and function of the Teething Crib Rail and Entertainment Pad. The broken lines showing an environment is for illustrative purposes only and forms no port of the claimed application.

FIG. 1: is the three-quarters elevation view of a crib in broken lines with a teething rail pad assembly mounted on all four crib rails.

FIG. 2: is the exploded elevation view of the set of four teething rail assemblies with the parts of the pads indicated.

FIG. 3: is the side end and corner elevation view of the teething rail pad assembly.

FIG. 4: is the inside elevation view of the teething rail pad assembly and the flavor tube.

### DETAILED DESCRIPTION OF THE PREFERRED EMBODIMENT

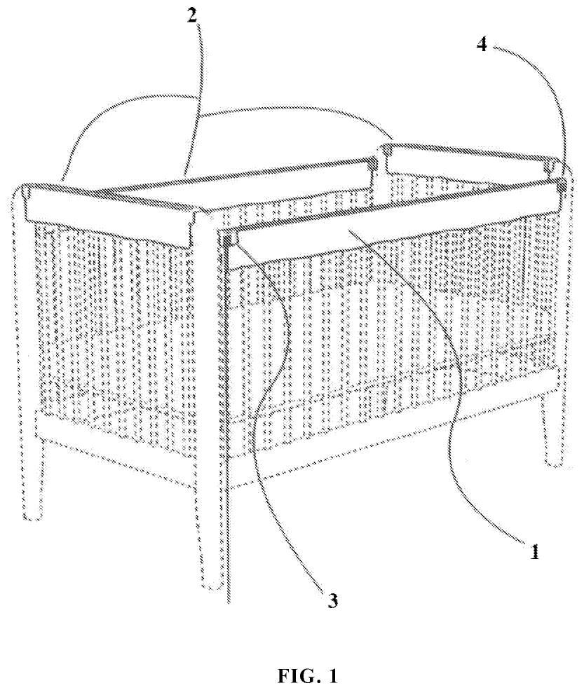

In FIG. 1, the crib is shown in broken lines and teething rail pad assemblies are shown mounted on the crib rails, each of the teething rail pad assemblies having a lower teething rail pad 1 on top of which is mounted an upper teething rail 2 having chewing knobs 12 and an electronic component assembly 3 (optional) imbedded into the plastic end piece 13 with a speaker 4 (optional) on the outside of the rail system for outputting from an entertainment system.

Collectively, the lower teething rail pad 1 and the upper teething rail 2 are configured so that they cover substantially the entire portion of the crib rail and a good portion (depicted) or all (not shown) of the crib bars. The upper teething rail 2 in addition to or in lieu of the chewing knobs 12 can be contoured to attract, or, rather, divert, the attention of the teething child from his or her discomfort. The surface could contain bright colors, shapes, pictures, or anything else that might accomplish this function. The upper teething rail 2 is made of soft, pliable plastic and is non-toxic as it will bear the brunt of the child's teething. The length is designed to cover the entire crib rail length as a single sheet and is in one preferred embodiment not modular, but alternatively in a second, less-preferred embodiment could be modular and made of several lengths (e.g., 2, 3 or 4 modular pieces) joined together to span the total length of the crib railing.

The lower teething rail pad 1 is intended to cover the bars with padding and, thereby, both to prevent the teething child from chewing at least on the upper portion of the crib bars, and to protect the teething child from being injured by the crib bars, for example, by falling against the crib bars. Accordingly, the hanging length of the lower teething rail pad 1 can be any desired fixed length, or the length could be adjustable, for example, by rolling up a portion of the pad upon itself, or by adding sectional pieces, for example, secured to the existing hanging pad portion by Velcro® (hook and loop fastener) or by other suitable means, for example, cooperating buttons and button holes, or snaps. The lower teething rail pad 1 is preferably made of a soft fabric, for example, cotton, preferably organic cotton, especially quilted, or a soft, pliable plastic. The lower teething rail pad 1 might also, if desired, be fitted with chewing knobs or other structures to alleviate teething pain.

In one embodiment, both the lower teething rail pad 1 and the upper teething rail 2 are single pieces designed to cover the entire crib rail length from one end of the crib to the adjacent end. The standard full-size crib, for example, has dimensions of 30 inches by 54 inches. Given a 1-inch rail thickness, the length of the long rails would be 52 inches, whereas the length of the short rails would be 28 inches. Accordingly, if the lower teething rail pad 1 and the upper teething rail 2 are each provided in approximately 52-inch and 28-inch lengths, these will be sufficient to cover the cribs rails of a standard full-size crib. Other lengths can be provided for other sized cribs.

In another embodiment, the length of the lower teething rail pad 1 is sufficient to cover the length of the crib bars from the top of the crib rail to at least the top of the crib mattress.

In another embodiment, the length of the lower teething rail pad 1 is insufficient to cover the length of the crib bars from the top of the crib rail to at least the top of the crib mattress. In a preferred embodiment, the hang of the lower teething rail pad 1 is sufficient to cover one-quarter, or one-half, or three-quarters of the length of the crib bars from the top of the crib rail to at least the top of the crib mattress.

In an especially preferred embodiment, both the lower teething rail pad 1 and the upper teething rail 2 are single pieces designed to cover the entire crib rail length from one end of the crib to the adjacent end; and the length of the lower teething rail pad 1 is sufficient to cover the length of the crib bars from the top of the crib rail to at least the top of the crib mattress. In one most preferred embodiment of the foregoing, the lower teething rail pad 1 and the upper teething rail 2 are separate from one another and not permanently joined. In another most preferred embodiment of the foregoing, the lower teething rail pad 1 and the upper teething rail 2 are separate from one another and not permanently joined.

In another especially preferred embodiment, both the lower teething rail pad 1 and the upper teething rail 2 are single pieces designed to cover the entire crib rail length from one end of the crib to the adjacent end; and the length of the lower teething rail pad 1 is insufficient to cover the length of the crib bars from the top of the crib rail to at least the top of the crib mattress, optionally covering only one-quarter, or one-half, or three-quarters of the length of the crib bars from the top of the crib rail to at least the top of the crib mattress. In one most preferred embodiment of the foregoing, the lower teething rail pad 1 and the upper teething rail 2 are separate from one another and not permanently joined. In another most preferred embodiment of the foregoing, the lower teething rail pad 1 and the upper teething rail 2 are separate from one another and not permanently joined.

In the normal situation, a commercial kit will comprise four lower teething rail pads 1 and four upper teething rails 2, although, as alluded to above, and as will be explained in greater detail below, the four lower teething rail pads 1 need not be identical in construction and/or the four upper teething rails 2 likewise need not be identical in construction. (Depending on whether each lower teething rail pad 1 is permanently joined to an upper teething rail 2, such a kit would, therefore, contain either four teething rail assemblies; or eight teething rail components intended to be combined by the end user to form four teething rail assemblies.) Thus, for example, one of the four lower teething rail pads 1 will comprise an LCD screen for entertaining the teething child. The LCD screen need only be embedded into or mounted onto one of the four lower teething rail pads 1, whereas the remaining three lower teething rail pads 1 will be free of the LCD screen, but could contain other electronics, for example, speakers, electronic games, lights, etc. Similarly, one or some of the upper teething rails 2 can contain features that the others do not. For example, one, some or all of the upper teething rails 2 might be made to vibrate, or to vary in their surface contours, or to vary in their composition (e.g., rubber for some, and plastic or other material for others).

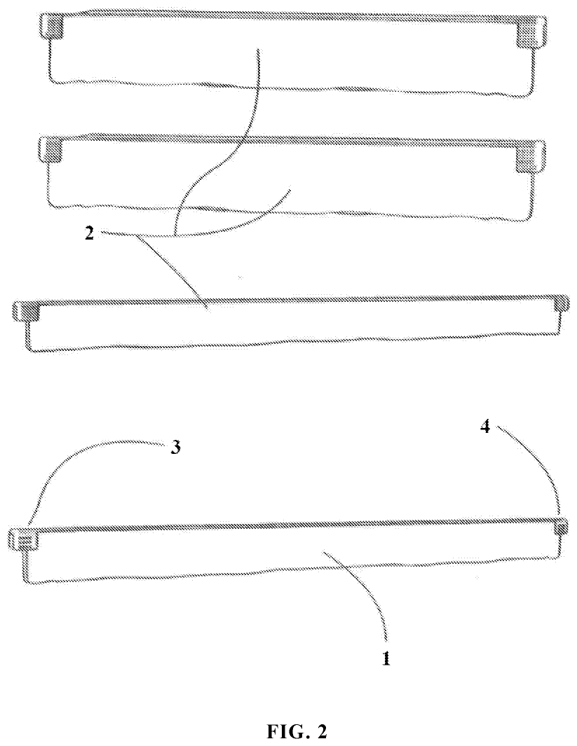

FIG. 2 shows the teething rail pad assembly parts with the lower teething rail pad 1 with the upper teething rail 2 with chewing knobs 12 and with an electronic component assembly 3 imbedded into the plastic end piece 13 with a speaker 4 on the outside of the rail system for outputting from an entertainment system. (Although the speaker 4 has been shown here on an end of the upper teething rail 2, the speaker could be located anywhere along the upper teething rail 2, or could even be a part of the LCD unit embedded in the lower teething rail pad 1.)

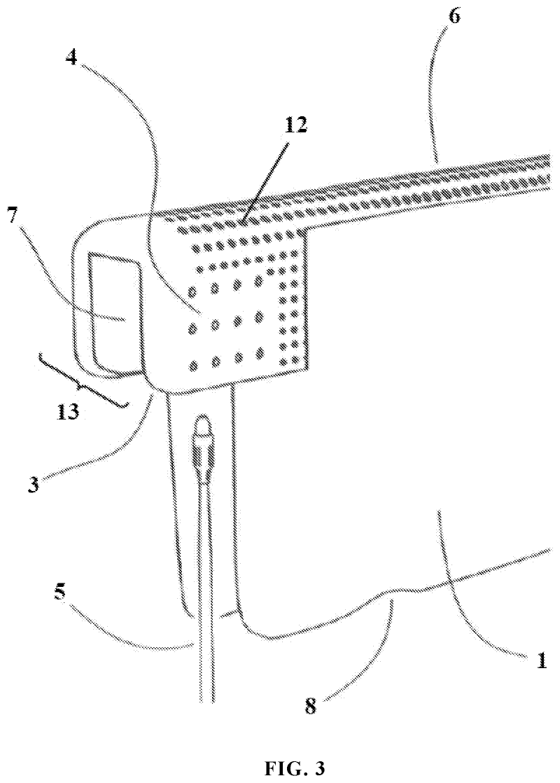

In this embodiment, which is shown for illustrative purposes only, the upper teething rail comprises an elongated central portion and two end portions, the two end portions having a U-shaped cross-sectional shape that holds the entire teething assembly in place on the crib rail, whereas the elongated central portion is flattened and other than connecting the two end portions does not contribute to the holding of the teething assembly in place on the crib rail. The upper teething rail 2 can be permanently joined to the lower teething rail pad 1 (for example, by a hot melt adhesive, or stitching, or other suitable connector) or, alternatively, the two parts can be separate and joined together by the end user on the crib rail. In either case, the upper teething rail 2 serves to hold the entire assembly, including the lower teething rail pad 1, in its proper place on the crib rail, and, thus, acts like a clothespin pinning the lower teething rail pad 1 to the crib rail line. The flat portion may arc slightly from the center towards the ends forcing the two ends into closer contact with the lower teething rail pad 1 and the crib rail beneath. The hold should be sufficient that the teething child will have great difficulty dislodging the assembly. In a preferred embodiment, the upper teething rail 2 is composed of a material that can be pressed into a new position, for example, a plastic thermoformable with moderate heat, and holds itself there until repositioned. In this way, the upper teething rail 2 can be pressed against the crib rails where it will take hold and thereby hold the entire assembly in place against the crib rail until the upper teething rail 2 is again manipulated and repositioned. Alternatively, the upper teething rail 2 can be made sufficiently rigid in certain places, for example, in the ends 13 (shown in FIG. 3), as necessary to fit tightly around the lower teething rail pad 1 and the crib rail beneath. In this latter embodiment, of course, the configuration of the upper teething rail 2 must be sufficient to circumvent the combined thicknesses of the crib rail with the lower teething rail pad 1 mounted on top.

FIG. 3 shows the end 13 and corner of the teething rail pad assembly with the lower teething rail pad 1 with an electronic component assembly 3 imbedded into the plastic end piece 13 with a speaker 4 on the outside of the rail system for outputting from an entertainment system with a cord 5 for charging an internal battery to power the entertainment system with a pliable rubber or plastic portion 6 with raised knobs 12 to stimulate a child's gum for teething with an inner pliable rubber or plastic portion 7 that will mold to or is original formed to snuggly fit various shapes and sizes of crib rails with a padded fabric portion 8 hanging beneath to protect the child against injury by the crib bars.

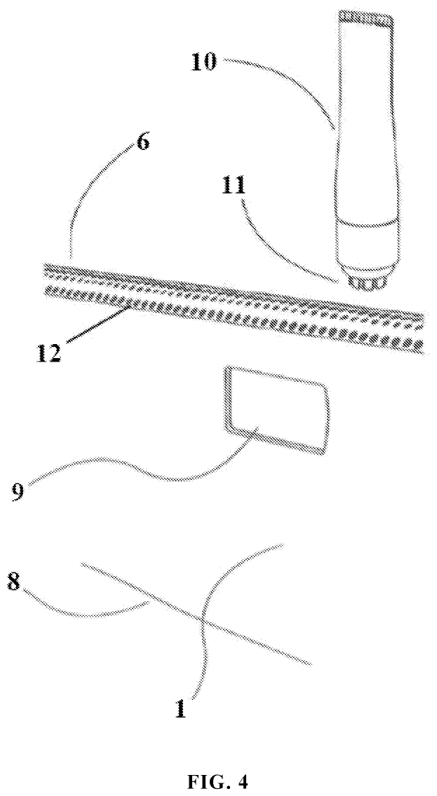

FIG. 4 shows the inside-the-crib portion of the lower teething rail pad 1, and the entertainment embedding, the pliable rubber or plastic portion 6 with raised knobs 12 to stimulate a child's gum for teething and a padded fabric portion 8 to protect the child against the crib bars, with an embedded LCD screen 9 for playing videos to stimulate the child, and, optionally, a flavor tube 10 that spreads flavoring onto the pliable rubber or plastic portion 6 with raised knobs 12 for the delight of the teething child, there being provided a brush 11 on the flavor tube 10 to spread the flavoring onto the pliable rubber or plastic portion 6 with raised knobs 12. Instead of being embedded in the lower teething rail pad 1, the LCD screen 9 might be mounted on the lower teething rail pad 1. In one embodiment, the flavoring includes a mild analgesic, for example, acetaminophen, ibuprofen, or the like, for lessening the child's pain. (Aspirin should be avoided because of links to Reye Syndrome.)

In an alternative embodiment, the LCD screen might be removed from the lower teething pad 1 altogether, and instead placed in a portion of the upper teething rail 2 configured to hang down below the top of the crib rail.

The Teething Crib Rail and Entertainment Pad is a complete system for a child when in the crib is protected by a pad around the perimeter of the crib rails with a pliable rubber or plastic teething rail with knobs on the rail to stimulate the child while teething. The upper teething rail 2 of the assembly is designable to fit onto any size crib rail and makes the system stay in place and not move around while the child is gripping or teething on the rail. The lower teething rail pad 1 contains an LCD screen to show videos, programs and such to stimulate the child as they are in the crib. It can be programmable for any type of software and is powered by a battery inside the plastic or rubber body of the rail with a cord that when plugged into the speaker portion and the battery portion of the rail system will charge the battery. The cord is easily removed when the child is in the crib so that there is no danger to the child chewing through the cord. A flavor tube with a brush can be used to apply any type of flavoring (alone or with an analgesic added) directly to the teething rail to enhance the teething experience of the child. The pad can be any color or can have designs on the pad in bright colors to stimulate the child as well. In one embodiment, the upper portion of the teething rail is designed and molded to fit tightly onto any size crib rail by applying pressure to each side of the crib rail and holding into place. The teething rail has small knobs on the rail which are used to stimulate the child as they are teething. This system is a complete system that can be used by children of an older age if necessary and is perfect for young children to stimulate their thought process. The LCD screen can also be interactive with the child touching the screen like so much of the technology today. It can be customized as to the programing, which can increase a market size for the invention.

While the present invention has been described in conjunction with the specific embodiments set forth above, many alternatives, modifications and other variations thereof will be apparent to those of ordinary skill in the art. All such alternatives, modifications and variations are intended to fall within the spirit and scope of the present invention.

### DRAWING ELEMENTS

1 lower teething rail pad
2 upper teething rail
3 electronic component assembly
4 speaker
5 cord for internal battery
6 pliable rubber or plastic outer portion with raised knobs
7 pliable rubber or plastic inner portion
8 padding
9 LCD screen
10 flavor tube
11 tube brush
12 chewing knobs
13 end portion

1. A teething rail assembly comprising:
(a) a lower teething rail pad;
(b) an upper teething rail mounted on and partially covering the lower teething rail pad; and
(c) an LCD screen mounted in or on the lower teething rail pad;
wherein the upper teething rail has a cross-sectional shape in at least a portion of the upper teething rail such that when the teething rail assembly is mounted onto a crib rail, said at least a portion of the upper teething rail holds the entire teething rail assembly in place on the crib rail;
wherein the lower teething rail pad and the upper teething rail are configured such that when the teething rail assembly is mounted onto said crib rail, a portion of the lower teething rail pad hangs beneath the upper teething rail; and
wherein the LCD screen is mounted in or on the portion of the lower teething rail pad that hangs beneath the upper teething rail and is visible and accessible to a child in the crib.

2. The teething rail assembly according to claim 1, which further comprises at least one speaker mounted in the upper teething rail, which speaker projects noise output from the LCD screen.

3. The teething rail assembly according to claim 1, wherein the upper teething rail comprises an elongated central portion and two end portions, the two end portions having a U-shaped cross-sectional shape that holds the entire teething assembly in place on the crib rail, whereas the elongated central portion is flattened and other than connecting the two end portions does not contribute to the hold of the teething assembly in place on the crib rail.

4. The teething rail assembly according to claim 3, wherein the at least one speaker is contained in at least one of said end portions.

5. The teething rail assembly according to claim 4, which has at least one speaker in each of said end portions.

6. The teething rail assembly according to claim 1, which comprises a power source operably linked to said LCD screen and/or said at least one speaker.

7. The teething rail assembly according to claim 6, wherein the power source is a battery, especially a rechargeable battery, also contained in at least one of said end portions.

8. The teething rail assembly according to claim 7, which further comprises a plug also contained in at least one of said end portions, for connecting via a cord to a wall socket.

9. The teething rail assembly according to claim 1, wherein the upper teething rail comprises a plurality of chewing knobs on a surface thereof for simulating a teething child's gums.

10. The teething rail assembly according to claim 1, wherein the upper teething rail is capable of vibrating.

11. A teething rail assembly comprising:
(a) a lower teething rail pad; and
(b) an upper teething rail mounted on and partially covering the lower teething rail pad;
wherein the upper teething rail has a cross-sectional shape in at least a portion of the upper teething rail such that when the teething rail assembly is mounted onto a crib rail, said at least a portion of the upper teething rail holds the entire teething rail assembly in place on the crib rail; and
wherein the lower teething rail pad and the upper teething rail are configured such that when the teething rail assembly is mounted onto said crib rail, a portion of the lower teething rail pad hangs beneath the upper teething rail.

12. The teething rail assembly according to claim 11, wherein the upper teething rail comprises an elongated central portion and two end portions, the two end portions having a U-shaped cross-sectional shape that holds the entire teething assembly in place on the crib rail, whereas the elongated central portion is flattened and other than connecting the two end portions does not contribute to the hold of the teething assembly in place on the crib rail.

13. The teething rail assembly according to claim 12, wherein the at least one speaker is contained in at least one of said end portions.

14. The teething rail assembly according to claim 13, which has at least one speaker in each of said end portions.

15. A kit comprising a first teething rail assembly and a second teething rail assembly, wherein the first teething rail assembly comprises:
(a1) a first lower teething rail pad;
(b1) a first upper teething rail mounted on and partially covering the first lower teething rail pad; and
(c1) an LCD screen mounted in or on the first lower teething rail pad;
wherein the first upper teething rail has a cross-sectional shape in at least a portion of the first upper teething rail such that when the first teething rail assembly is mounted onto a crib rail, said at least a portion of the first upper teething rail holds the entire first teething rail assembly in place on the crib rail;
wherein the first lower teething rail pad and the first upper teething rail are configured such that when the first teething rail assembly is mounted onto said crib rail, a portion of the first lower teething rail pad hangs beneath the first upper teething rail; and
wherein the LCD screen is mounted in or on the portion of the first lower teething rail pad that hangs beneath the first upper teething rail and is visible and accessible to a child in the crib; and
wherein the second teething rail assembly comprises:
(a2) a second lower teething rail pad; and
(b2) a second upper teething rail mounted on and partially covering the second lower teething rail pad;
wherein the second upper teething rail has a cross-sectional shape in at least a portion of the second upper teething rail such that when the second teething rail assembly is mounted onto a crib rail, said at least a portion of the second upper teething rail holds the entire second teething rail assembly in place on the crib rail; and
wherein the second lower teething rail pad and the second upper teething rail are configured such that when the second teething rail assembly is mounted onto said crib rail, a portion of the second lower teething rail pad hangs beneath the second upper teething rail.

16. The kit according to claim 15, which comprises:
(a) exactly one teething rail assembly (a); and
(b) exactly three teething rail assemblies (b).

17. The kit according to claim 14, which additionally comprises a tube comprising a flavored, edible substance.

18. The kit according to claim 17, wherein the flavored, edible substance comprises a mild analgesic.
